(19) United States
(12) Patent Application Publication
(10) Pub. No.: US 2008/0059752 A1
(43) Pub. Date: Mar. 6, 2008

(54) Virtualization system and region allocation control method

(75) Inventor: Kazuyoshi Serizawa, Tama (JP)

Correspondence Address: SUGHRUE MION, PLLC, 2100 PENNSYLVANIA AVENUE, N.W., SUITE 800, WASHINGTON, DC, 20037, US

(73) Assignee: HITACHI, LTD., Tokyo (JP)

(21) Appl. No.: 11/584,774

(22) Filed: Oct. 20, 2006

(30) Foreign Application Priority Data
Aug. 31, 2006 (JP) 2006-236501

(51) Int. Cl. G06F 12/00

(52) U.S. Cl. 711/173

(57) ABSTRACT

To provide a region allocation control method for determining whether a virtual volume is being formatted or not, specifying an unallocated real region out of a plurality of real regions with reference to management information when it is determined that the virtual volume is being formatted, dividing the specified unallocated real region into a plurality of sub regions, and allocating the plurality of sub regions to each of successive regions which are arranged at regular intervals in the virtual volume.

### CROSS-REFERENCE TO PRIOR APPLICATION

This application relates to and claims priority from Japanese Patent Application No. 2006-236501, filed on Aug. 31, 2006, the entire disclosure of which is incorporated herein by reference.

### BACKGROUND

The present invention generally relates to storage technology and more specifically to technology for allocating storage regions to virtual storage devices used by a host computer (e.g.; Thin Provisioning technology).

Virtualization devices designed for providing virtual storage devices (“virtual volume(s)”, hereinafter) to a host computers such as, for example, the device disclosed in Japanese Patent Application Laid-Open No. 2005-11316, are well known in the art.

The aforesaid virtualization device is usually connected to a storage system having a plurality of logical storage regions (real regions). When the virtualization device receives a write request corresponding to a virtual volume, the virtualization device allocates the real regions in the storage system to the target virtual volume. The technology described in Japanese Patent Application Laid-Open No. 2005-11316 can allocate the aforesaid real regions of varying sizes. When the virtualization device receives the write request based on a predetermined processing such as format processing, the virtualization device reduces the size of a real region and allocates the reduced-size real region to the virtual volume.

When a file system which uses a virtual volume is formatted (initialization), a small amount of management data called “metadata” is written into the virtual volume, and transition of the write destination for the metadata is made at regular intervals. For this reason, by reducing the size of the real regions and then allocating the reduced-size real regions to the virtual volumes, the size of an unused region within each allocated real region can be reduced more, compared to the case where the real regions are allocated without having their size reduced.

However, if the real regions are reduced in their size and then allocated to the virtual volume, in some cases the number of real regions to be allocated to the virtual volumes increases, compared to the situation where the real regions are allocated to the virtual volumes without having their size reduced.

If the number of real regions to be allocated to the virtual volumes increases, the amount of information necessary for managing the allocated real regions (“management information”, hereinafter) also expands, resulting in the increased requirements of the number of storage capacities in storage regions for storing the allocation management information.

Moreover, the aforesaid management information also includes information identifying those of the plurality of real regions, which are not yet allocated. If the number of real regions to be allocated to the virtual volumes increases, the access frequency to the management information also increases in order to enable the search for the unallocated real region(s) to be allocated to the virtual volume, which results in increasing of the time required for the allocation.

One possible solution to these problems involves allocating real regions to virtual volumes without reducing the size of the real regions. In this case, however, there occurs a problem in which the size of the unused parts increase within the respective allocated real regions.

Therefore, an aspect of the present invention prevents the occurrence of unused parts in allocated regions and also prevents the increase of the number of real regions to be allocated, when formatting a file system which uses a virtual volume.

Other aspect(s) of the present invention will become clear from the descriptions hereinafter.

### SUMMARY

A virtualization system according to an embodiment of the present invention is operable to allocate an unallocated real region of a plurality of real regions to a write destination of a write request for a virtual volume provided to a host device, the virtualization system comprising: a request receiving section, which receives the write request for the virtual volume; a determining section, which, when the write request for the virtual volume is received, determines whether the virtual volume is being formatted or not; a storage section, which stores management information having information indicating whether or not each of the plurality of real regions is unallocated; and a region allocation control section. When it is determined that the virtual volume is being formatted, the region allocation control section specifies an unallocated real region out of the plurality of real regions with reference to the management information, divides the specified unallocated real region into a plurality of sub regions, and allocates the plurality of sub regions to each of successive regions which are arranged at regular intervals in the virtual volume.

In a first aspect, when it is determined that the virtual volume is not being formatted, the region allocation control section allocates the specified unallocated real region itself to the write destination of the write request, in response to the write request for the virtual volume.

In a second aspect, the storage capacity of the real region and the storage capacity of each of the sub regions are both of a fixed value.

In a third aspect, the region allocation control section allocates the successive sub regions to each write destination in the format in the first successive region of the virtual volume, and, when allocating a sub region to the first write destination of a subsequent successive region, obtains a successive region interval which is the difference between the write destination and the first write destination of the first successive region, and further allocates successive sub regions, the number of which is the number of the sub regions allocated to the first successive region, to each of successive regions following the subsequent successive region.

In a fourth aspect, according to the third aspect, prior to receiving a write request for each of the successive regions following the subsequent successive region, the region allocation control section allocates successive sub regions to each of the successive regions following the subsequent successive region.

In a fifth aspect, according to the third aspect, after allocating the successive sub regions to the successive regions following the subsequent successive region, the region allocation control section allocates an unallocated real region to the write request, when the position of the write destination of the received write request is different from that of the successive region regardless of that the virtual volume is being formatted.

In a sixth aspect, according to the fifth aspect, the virtualization system further comprises a counting section, which counts the number of times that the position of the write destination of the received write request is different from that of the successive region. When the number of times exceeds a predetermined value, the determining section determines that the virtual volume is not being formatted.

In a seventh aspect, the virtualization system further comprises a notification receiving section, which receives a notification of the start of formatting of the virtual volume and a notification of the end of the formatting from the host device or an external device which is different from the host device. When the notification of the start of formatting is received, the determining section determines, until the notification of the end of the formatting is received, that the virtual volume is being formatted.

In an eighth aspect, the virtualization system further comprises a notifying section, which notifies a predetermined computer of a successive region interval which is the difference between a base point of a certain successive region and a base point of a subsequent successive region, and the number of sub regions allocated to one successive region.

In a ninth aspect, the virtualization system further comprises an input section, which inputs the successive region interval and the number of sub regions from the outside of the virtualization system. The region allocation control section allocates successive sub regions, the number of which is the number of the inputted sub regions, at the inputted successive region intervals.

In a tenth aspect, the virtualization system is a storage system. The storage system comprises a plurality of storage devices and a controller. The plurality of storage devices are provided with at least one logical volume constituted from the plurality of real regions. The controller has the request receiving section, determining section, storage section, and region allocation control section. The region allocation control section writes data corresponding to a write request received by the request receiving section, into an allocated sub region.

In an eleventh aspect, the virtualization system is a storage system connected to an external storage system. The storage system comprises a plurality of storage devices and a controller. The external storage system is provided with at least one logical volume constituted from the plurality of real regions. The controller has the request receiving section, determining section, storage section, and region allocation control section. The region allocation control section writes data corresponding to a write request received by the request receiving section, into an allocated sub region.

In a twelfth aspect, the virtualization system is a switching device, which is disposed between the host device and the storage system. The plurality of real regions are components of at least one logical volume provided in the storage system.

In a thirteenth aspect, the virtualization system comprises the switching device disposed between the host device and the storage system, and a management device connected communicably with the switching device. The switching device has the request receiving section and a requesting section which requests for determination on whether the virtual volume is being formatted or not. The management device has the determining section which performs the determination in response to the request, the storage section, and the region allocation control section.

In a fourteenth aspect, the management information includes first management sub information for managing allocation of a real region itself to the virtual volume, and second management sub information for managing allocation of a sub region to the virtual volume. The region allocation control section updates the first management sub information when the unallocated real region itself is allocated to the virtual volume, and updates the second management sub information when the sub region is allocated to the virtual volume.

In a fifteenth aspect, according to the fourteenth aspect, the second management sub information includes a successive region interval, which is the difference between a base point of a certain successive region and a base point of a subsequent successive region, and the number of sub regions allocated to one successive region.

The storage section provided in the abovementioned virtualization system can be constructed from, for example, a storage resource such as memory. Furthermore, other sections can be constructed from hardware, a computer program, or a combination thereof (for example, some of the sections are realized with a computer program and the rest of the sections are realized with hardware). The computer program is read into a predetermined processor and then executed. When the computer program is read into the processor and information processing is performed, a storage region existing in a hardware resource such as memory may be used accordingly. Moreover, the computer program may be installed from a recording medium such as a CD-ROM into a computer or may be downloaded into the computer via a communication network.

### BRIEF DESCRIPTION OF THE DRAWINGS

The accompanying drawings, which are incorporated in and constitute a part of this specification exemplify the embodiments of the present invention and, together with the description, serve to explain and illustrate principles of the inventive technique. Specifically:

FIG. 1 shows a configuration example of a computer system to which the virtualization device according to a first embodiment of the present invention is applied;

FIG. 2 shows an internal configuration example of a virtualization device 11;

FIG. 3A shows a configuration example of a nonperiodic allocation access conversion list;

FIG. 3B shows a configuration example of a periodic allocation access conversion list;

FIG. 3C shows a configuration example of a nonperiodic allocation chunk list;

FIG. 3D shows a configuration example of a periodic allocation access conversion list;

FIG. 4 shows a configuration example of a storage system 13;

FIG. 5 is an explanatory diagram of periodic allocation;

FIG. 6 shows an example of a flow of processing performed by a control program 212 which receives an I/O request;

FIG. 7 shows the details of processing in step S200 shown in FIG. 6;

FIG. 8 shows the detail of processing in S600 shown in FIG. 6;

FIG. 9 shows an example of a condition in which the periodic allocation access conversion list is updated;

FIG. 10 is an explanatory diagram of a first variation of a method of judging whether or not formatting is being performed;

FIG. 11 shows an example of a flow of processing performed in a second embodiment of the present invention;

FIG. 12A shows a part of an example of a flow of processing performed in a third embodiment of the present invention;

FIG. 12B shows a part of the rest of the example of the abovementioned processing;

FIG. 13 shows a flow of region allocation processing in the third embodiment;

FIG. 14 shows a configuration example of the computer system according to a fourth embodiment of the present invention;

FIG. 15 shows a configuration example of the virtualization device 11 and a virtual volume management server 5001; and

FIG. 16 shows an example of a flow of processing performed by the computer program 212 which receives an I/O request in the fourth embodiment.

### DESCRIPTION OF THE PREFERRED EMBODIMENTS

In the following detailed description, reference will be made to the accompanying drawing(s), in which identical functional elements are designated with like numerals. The aforementioned accompanying drawings show by way of illustration, and not by way of limitation, specific embodiments and implementations consistent with principles of the present invention. These implementations are described in sufficient detail to enable those skilled in the art to practice the invention and it is to be understood that other implementations may be utilized and that structural changes and/or substitutions of various elements may be made without departing from the scope and spirit of present invention. The following detailed description is, therefore, not to be construed in a limited sense. Additionally, the various embodiments of the invention as described may be implemented in the form of a software running on a general purpose computer, in the form of a specialized hardware, or combination of software and hardware.

### Embodiment 1

First, the brief overview of the first embodiment is provided. It should be noted in the following descriptions that, for the sake of convenience, a write request, which is based on format processing is referred to as “format write request,” while other type of write request is referred to as “normal write request”.

A host processor and a storage system are connected to a virtualization device. The storage system comprises a plurality of logical storage devices (hereinafter referred to as “LU” (logical unit)). In each LU, the virtualization device manages a plurality of storage regions composing the LU. For the sake of convenience, each of the plurality of storage regions in the LU is referred to as “chunk.” The chunk corresponds to the abovementioned real region.

When a normal write request directed to a virtual volume is received, the virtualization device allocates storage regions to the virtual volume in chunk units. Specifically, the virtualization device allocates an unallocated chunk out of the plurality of chunks in the storage system to the write destinations in the virtual volume in accordance with the normal write request. Then, the virtualization device transmits, to the storage system, a write request for writing data corresponding to the normal write request into the allocated chunk, and thereby writes the data corresponding to the normal write request into the allocated chunk.

On the other hand, when a format write request for the virtual volume is received, the virtualization device allocates the storage regions to the virtual volume in page units instead of chunk units. The term “page” used in the description of the present embodiment means each of a plurality of sub regions which are generated by dividing a chunk. Specifically, in the case, wherein the format write request for the virtual volume is received, an unallocated chunk is divided into a plurality of pages, and each page obtained by such division is allocated to a virtual volume. The virtualization device has a storage section for storing management information. The management information includes information identifying which of the plurality of chunks are unallocated, as well as other information elements in chunk units. With respect to the plurality of pages, however, information elements, such as information identifying which of the plurality of pages are unallocated, are not included in page units.

In this first embodiment, pages, which are storage regions that are smaller than chunks, are allocated when a file system which uses a virtual volume is being formatted, thus the occurrence of an unused section in an allocated region can be prevented. Furthermore, although the management information includes information elements in chunk units, it does not include information elements in page units. Therefore, it is not necessary to access the management information each time when a page is allocated, thus the increase of the time required for allocation can be prevented.

The first embodiment will now be described in detail.

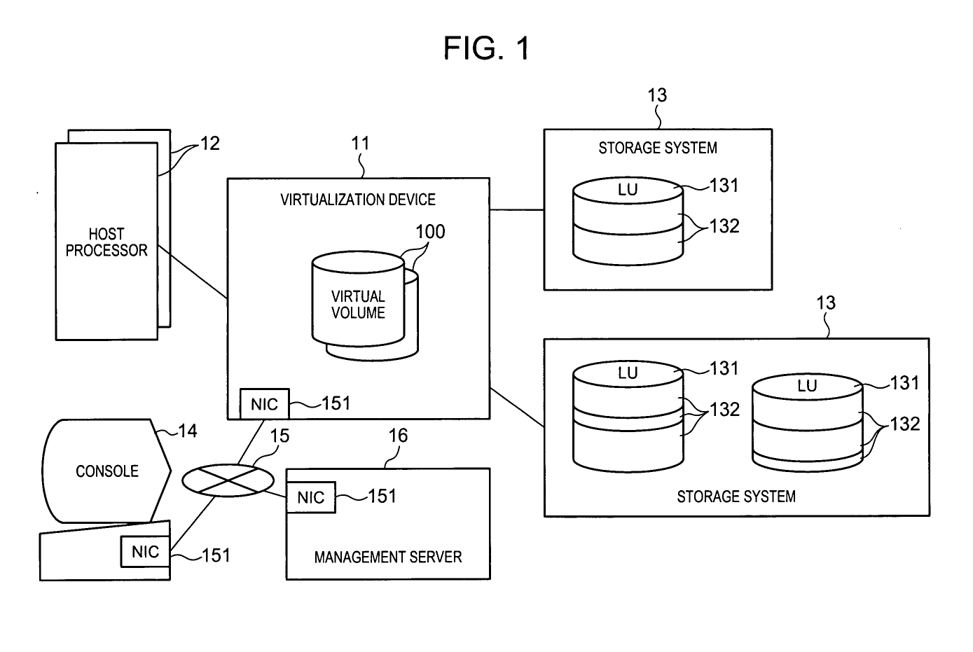

FIG. 1 shows a configuration example of a computer system to which the virtualization device according to the first embodiment of the present invention is applied.

The computer system comprises a virtualization device 11, at least one host processor 12, at least one storage system 13, a console 14, and a management server 16. The at least one host processor 12 and the at least one storage system 13 are connected to the virtualization device 11. Moreover, a NIC (Network Interface Card) 151 of the virtualization device 11, a NIC 151 of the console 14, and a NIC 151 of the management server 16 are connected to a communication network, which may be implemented, for example, as a LAN (Local Area Network) 15.

The host processor 12 is a computer which uses data stored in the storage system 13. The host processor 12 issues an I/O request (write request/read request) to the virtualization device 11. The host processor 12 may be a file server which has a function of providing a storage region provided by the virtualization device 11 to other computer which is not connected to the virtualization device 11.

The storage system 13 is a system comprising a plurality of storage devices. Two or more of the plurality of storage devices form a group which is organized in accordance with the rules of a RAID system (Redundant Array of Independent (or Inexpensive) Disks) (RAID group). One or a plurality of logical storage devices (“logical unit” (LU), hereinafter) 131 are formed by a storage resource provided by the RAID group. The LU 131 is constituted from a plurality of chunks 132. In the present embodiment, the all of the chunks 132 are of the same fixed size, but the size of the plurality of chunks 132 may be different from one another or made variable. Each chunk 132 is a region having a sequential address.

The virtualization device 11 is a switch disposed between the host processor 12 and the storage system 13 (as described hereinafter, the functionality of the virtualization device 11 may be incorporated into the storage system 13 so that the virtualization device functions as the storage system). The virtualization device 11 manages one or a plurality of virtual volumes 100. In response to a write request directed to the virtual volume 100, the virtualization device 11 allocates an unallocated chunk 132 out of the plurality of chunks 132 in at least one storage system 13, or pages generated by dividing the unallocated chunk 132, to the virtual volume 100. Then, the virtualization device 11 transmits a write request, which designates the allocated chunk 132 or an address within the corresponding page, to the storage system 13 having this chunk 132 or page, and thereby writes data into the allocated chunk 132 or page. Accordingly, the virtualization device 11 can allocate the chunk 132 or page in response to the write request for the virtual volume 100.

The console 14 is a computer which is used by a system manager to create (set) the virtual volumes 100, and comprises a display device and an input device.

The management server 16 is a computer for managing the virtualization device 11. The management server 16 can receive information from the virtualization device 11 and transmit the received information to the console 14.

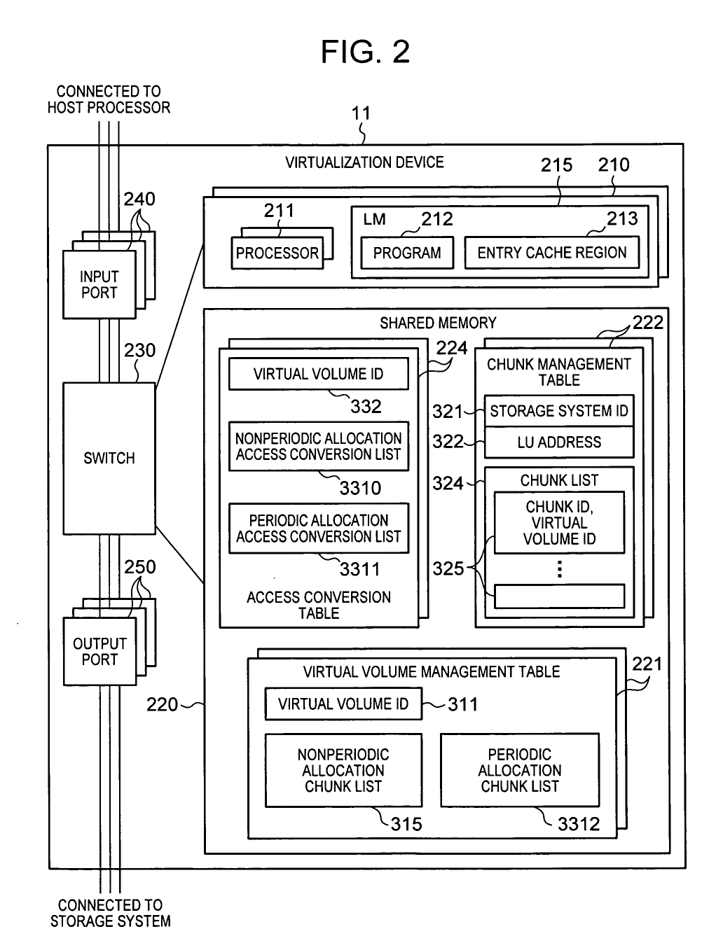

FIG. 2 shows an exemplary internal configuration of the virtualization device 11.

The virtualization device 11 comprises an input port 240, an output port 250, a switch 230, a processor package 210, and a shared memory 220.

The input port 240 is connected to a communication line through which the virtualization device 11 communicates with the host processor 12. The output port 250 is connected to a communication line through which the virtualization device 11 communicates with the storage system 13. It should be noted that the devices configuring the input port 240 and the output port 250 respectively may be the same. In this case, a user may select which port to use as the input port or output port. The virtualization device 11 can comprise one or a plurality of input ports 240 and/or output ports 250. At least the input port 240 or output port 250 may exist in the processor package 210.

The switch 230 can be configured from, for example, an LSI (Large Scale Integration) circuit. The switch 230 transfers an I/O request, which is received by the input port 240 from the host processor 12, to the output port 250 which is used for communication between the storage system 13, which is an access destination corresponding to the I/O request, and the virtualization device 11. Furthermore, the switch 230 transfers response information or data, which is received by the output port 250 from the storage system 13, to the input port 240, which is used for communication between the host processor 12, which should receive the data and the like, and the virtualization communication 11.

The processor package 210 can be implemented as a circuit board comprising a processor 211 and a memory (“local memory” (LM), hereinafter) 215. The control program 212, which is executed by the processor 211 is stored in the LM 215. Moreover, the LM 215 can be provided with a storage region (“entry cache region”, hereinafter) 213, which can cache the entries of each table stored in the shared memory 220. The processor 211 can refer to the information cached in the entry cache region 213, by executing the control program 212, and perform processing for converting the address of the access destination of the I/O request sent from the host processor 12.

The shared memory 220 is a memory shared by the plurality of processor packages 210, if more than one such processor package 210 is provided. In the present embodiment, although element 220 is referred to as “shared memory” for the sake of convenience, it may not be a “shared” memory in a literal sense in a configuration, which includes only one processor package 210. The shared memory 220 stores a virtual volume management table 221, chunk management table 222, and access conversion table 224.

The access conversion table 224 is present in each virtual volume 100, but it may exist in elements of other types, i.e. in each input port 240. The access conversion table 224 holds a nonperiodic allocation access conversion list 3310, a periodic access conversion list 3311, and an entry 332 for registering a virtual volume identifier of the virtual volume 100 corresponding to this table 224.

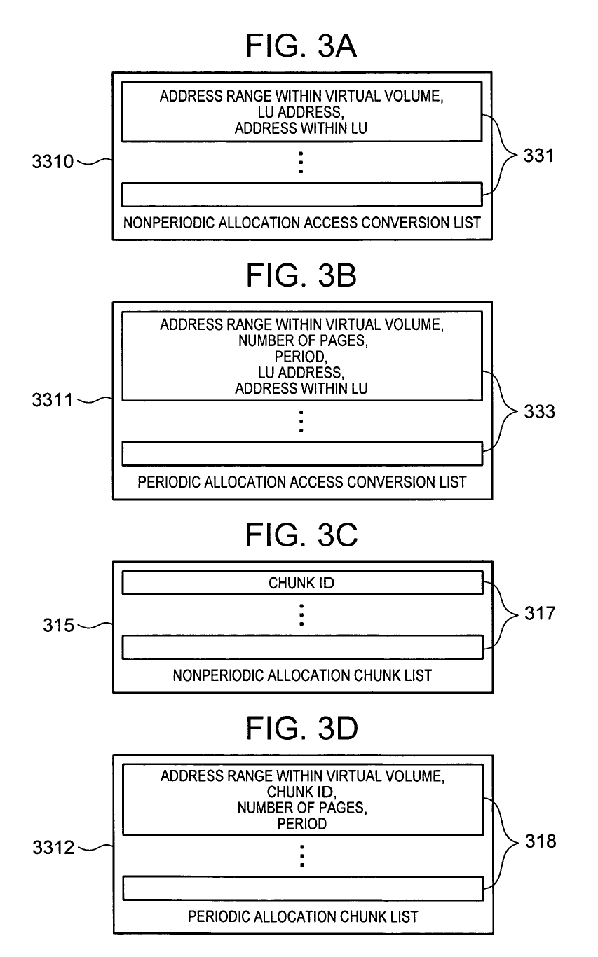

The nonperiodic allocation access conversion list 3310 has one or a plurality of entries 331 as shown in FIG. 3A, and, in each entry 331, an address range within the virtual volume 100, an identifier (LU address) of the LU 131 to which the chunk 132 corresponding to the address range belongs, and an address within LU indicating the position of the chunk 132 in the LU 131 are stored. The entries 331 may exist in, for example, each chunk 132 allocated to the virtual volume 100. Hereinafter, the address in the virtual volume is sometimes referred to as “virtual address”. Moreover, the LU address can be expressed in a combination of, for example, a WWN (World Wide Name) port ID and a LUN (logical unit number).

Furthermore, in the first embodiment, there are two types of allocations: “periodic allocation” and “nonperiodic allocation”. “Periodic allocation” is an allocation corresponding to writing in accordance with a format write request. Specifically, it is an allocation in which a destination for allocating a page to the virtual volume transits at regular intervals since a destination for writing data transits at regular intervals. In this first embodiment, “period” of allocation means an interval between a first virtual address of a virtual address range in which pages are successively allocated in the format processing (“successive page allocation region”, hereinafter) and a first virtual address in the next successive page allocation region, thus it does not mean time. However, in the first embodiment, allocation of regions can be carried out periodically in accordance with writing in accordance with the format write request, thus the term “periodic allocation” is used for the sake of convenience. On the other hand, “nonperiodic allocation” means an allocation of regions in accordance with writing in accordance with a normal write request. The normal write request is not an I/O request which is generated periodically, and a virtual address of a write destination does not transit regularly, thus the term “nonperiodic allocation” is used in the first embodiment for the sake of convenience.

As shown in FIG. 3B, a periodic allocation access conversion list 3311 has one or a plurality of entries 333, and, in each entry 333, an address range within the virtual volume 100, the number of pages allocated successively (sometimes referred to as “number of pages” simply, hereinafter), a period (an interval between a first virtual address of a successive page allocation region and a first address in the next successive page allocation region), an identifier of the LU 131 to which the chunk 132 corresponding to the address range belongs (LU address), and an address within LU indicating the position of the chunk 132 in the LU 131 are recorded. The entry 333 may exist in, for example, the chunk 132 allocated to the virtual volume 100. It should be noted that not the chunks 132 but pages are allocated periodically, thus “chunk which is allocated” here actually means a chunk which is an origin of allocated pages.

The chunk management table 222 exists for each LU 131, but it may be prepared in units of other types. The chunk management table 222 is a table used for managing the chunk 132 included in the LU 131. Each chunk management table 222 has an entry 321 in which a storage system ID is recorded, an entry 322 in which a LU address is recorded, and a chunk list 324. The storage system ID of the entry 321 is an ID for identifying the storage system 13 having the LU 131 to which this table 222 corresponds. The chunk list 324 has an entry 325 for each chunk 132 included in the LU 131 to which this table 222 corresponds. In each entry 325, an ID of a chunk to which the entry 325 correspond, and an ID of a virtual volume to which this chunk is allocated are registered. In the case where a chunk is unallocated, a value indicating that the chunk is unallocated (“null”, for example) is registered as the virtual volume ID. In this manner, the chunk management table 222 holds the information indicating whether each chunk 132 belonging to the LU 131 is allocated to the virtual volume 100 or not, and is used when the virtualization device 11 selects a new chunk 132 to be allocated to the virtual volume 100.

The virtual volume management table 221 exists in each virtual volume 100, but it may exist in units of other types. In each virtual volume management table 222, an identifier entry 311, a nonperiodic allocation chunk list 315, and a periodic allocation chunk list 3312 are stored.

In the identifier entry 311, a virtual volume identifier of the virtual volume 100 corresponding to the virtual volume management table 221 is recorded.

The nonperiodic allocation chunk list 315 is a list showing which chunk 132 is allocated to the virtual volume 100 corresponding to the virtual volume management table 221. As shown in FIG. 3C, in the nonperiodic allocation chunk list 315, entries 317 of the corresponding chunks 132 are arranged in order of virtual address on the virtual volume 100, and a chunk ID of the chunk 132 corresponding to the virtual address is stored in each entry 317.

As shown in FIG. 3D, in the periodic allocation chunk list 3312, information indicating which page of a chunk is allocated to which address range of the virtual volume 100 corresponding to the virtual volume management table 221 is recorded in each entry 318 of one or a plurality of entries 318. The abovementioned number of pages and period are also recorded in each entry 318. As described hereinafter, the number of pages also shows the number of pages which were allocated before determining the period when allocating a certain chunk periodically. Specifically, the periodic allocation chunk list 3312 also includes information for determining how to allocate a chunk periodically, when a chunk for periodic allocation exists.

As described above, the virtual volume management table 221 holds the information indicating which chunk 132 is associated with the storage region of the virtual volume 100, and is used when the virtualization device 11 determines how to perform periodic allocation.

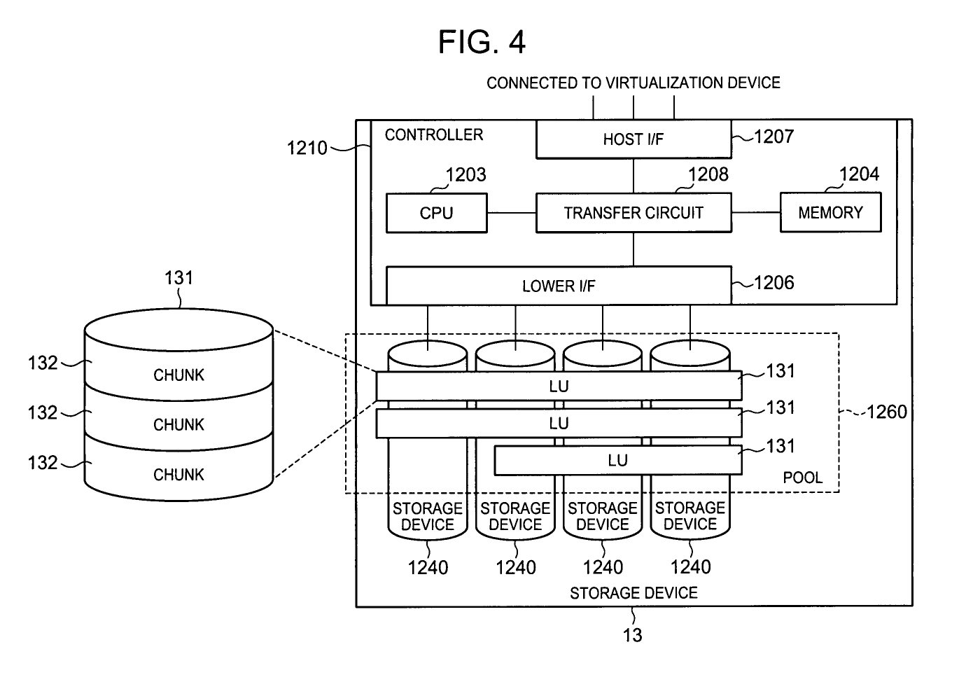

FIG. 4 shows an exemplary configuration of the storage system 13.

The storage system 13 comprises a plurality of storage devices 1240 and a controller 1210 which controls access from the virtualization device 11 to the storage devices 1240.

The storage device 1240 is a physical storage device, which may implemented using, for example, a hard disk or flash memory. Different types of storage devices may be mixed in the plurality of storage devices 1240. A RAID group (sometimes referred to as “parity group” or “array group”) is configured from two or more of the plurality of storage devices 1240. The RAID group is a group controlled in accordance with the RAID rules (Redundant Array of Independent (or Inexpensive) Disks). Each RAID group is characterized by a certain RAID level. A storage resource provided by the RAID group provides one or a plurality of LUs 131. At least one of the plurality of LUs 131 existing in the storage system 13 is configured from a chunks 132 having a predetermined. Each chunk 132 is a region which is dynamically allocated in response to a write request for the virtual volume 100. A storage region configured from the plurality of chunks 132 is called “pool 1260”.

The controller 1210 comprises an upper I/F 1207, lower I/F 1206, CPU 120, memory 1204, and transfer circuit 1208. The upper I/F 1207 is a communication interface having one or a plurality of communication ports and connected with a host device (virtualization device 11 in the present embodiment). An LU address can be configured from an ID of a communication port, WWN of the upper I/F 1207, and LUN allocated to the communication port. The lower I/F 1206 is a communication interface having one or plurality of communication ports and connected with the storage device 1240. The transfer circuit 1208 is an LSI for switching communications among the upper I/F 1207, lower I/F 1206, memory 1204 and CPU 1203. Various computer programs, which are executed in the CPU 1203, are stored in the memory 1204. The CPU 1203 controls access from the virtualization device 11 to the storage device 1240 by executing the computer programs stored in the memory 1204.

The above is the description of the computer system and the components of the computer system according to the first embodiment, but the various other configurations are possible and, therefore, the present invention is not limited by the above description. For example, the controller 1210 can comprise, instead of having the configuration described above, a plurality of first control sections for controlling communication with the host device (control circuit boards, for example), a plurality of second control sections for controlling communication with the storage device 1240 (control circuit boards, for example), a cache memory which can store data communicated between the host device and the storage device 1240, a control memory which can store data for controlling the storage system 13, and a connection section which connects each of the first control sections, each of the second control sections, the cache memory, and the control memory (a switch such as a crossbar switch). In this case, either or both first control section and second control section can collaborate with each other to perform the processing in place of the controller 1210 described hereinafter. The control memory may not be required, but in this case the cache memory may be provided with a region for storing information stored by the control memory.

One of the characteristics of the first embodiment is the periodic allocation processing. Periodic allocation is described hereinbelow. It should be noted that, in the case where the functionality described herein is implemented using a computer program, a processor (CPU) which executes the computer program actually performs the necessary processing.

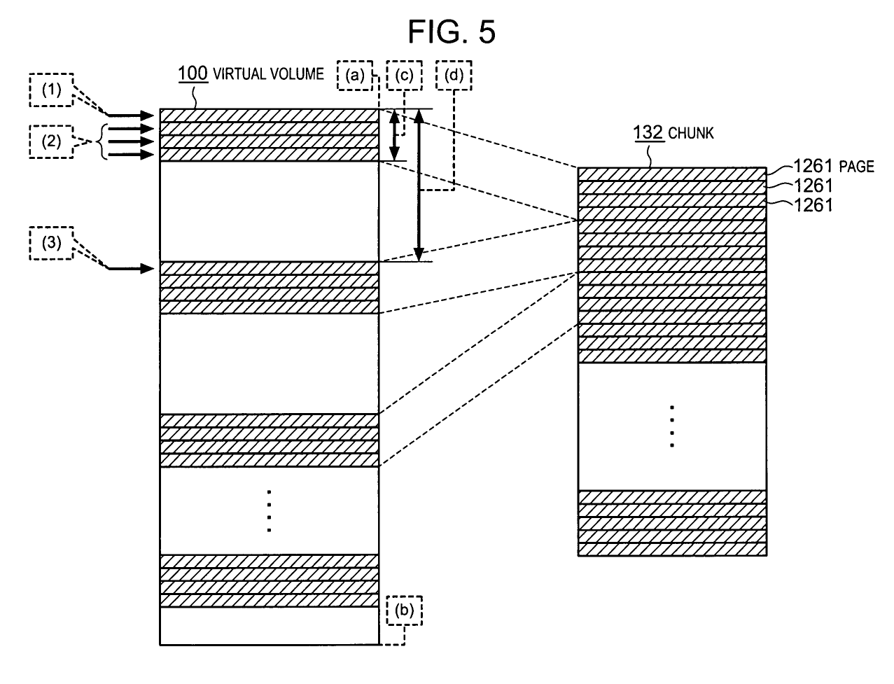

FIG. 5 is an explanatory diagram of periodic allocation.

For example, when a format command against the virtual volume 100 is received from the host processor 12 or the management console 14, the file system using the virtual volume 100 is initialized, i.e. formatted, by the control program 212. Specifically, the host processor 12 deletes the files and directories on the file system using the virtual volume 100 and issues, to the virtualization device 11, an I/O request for writing metadata (i.e. format write request) into the virtual volume 100, so that new files and directories can be created.

The control program 212 writes metadata into the virtual volume 100 at fixed intervals of virtual address in accordance with the format write request. Specifically, for example, the control program 212 writes first metadata from the first virtual address of the virtual volume 100, and then writes second metadata from a virtual address obtained by offsetting a predetermined virtual address from the first virtual address, after finishing writing the first metadata. In this manner, when writing metadata, the control program 212 allocates pages 1261 cut out from the unallocated chunk 132.

More specifically, as shown, for example, in step (1), when writing the first metadata into the virtual volume 100, the control program 212 divides the unallocated chunk 132 into a plurality of pages 1261, and allocates the first page 1261 of the plurality of divided pages 1261 (first page in the unallocated chunk 132) to the first virtual address of the virtual volume 100.

Next, as shown in step (2), the control program 212 writes the first metadata into a first successive page allocation region (range of successive virtual addresses) in accordance with the format write request. Therefore, the control program 212 successively allocates a second page 1261, third page 1261 and so on to the first successive page allocation region. Accordingly, a plurality of pages are allocated to the first successive page allocation region. It should be noted that in this step (2) the control program 212 counts the number of allocated pages.

After the writing of the first metadata is completed and when writing the second metadata into the virtual volume 100, the virtual address as the write destination according to the format write request becomes a different virtual address which is away from the first successive page allocation region, as shown in step (3). In other words, a second successive page allocation region starts from the different virtual address which is outside of the first successive page allocation region. In this case, the control program 212 allocates, to this different virtual address, a page subsequent to the last allocated page of the first successive page allocation region.

At this point, the number of pages (c) and the period (d) are found. Specifically, for example the number of pages (c) can be a value obtained by counting the pages allocated to the first successive page allocation region. Furthermore, the control program 212 can obtain the period (d) by computing the difference between the first virtual address of the first successive page allocation region and the first virtual address of the second successive page allocation region (the difference is expressed in, for example, LBA).

Subsequent to the first virtual address of the second successive page allocation region, the control program 212 successively allocates the pages 1261 on the basis of the obtained number of pates (c) and the period (d). Specifically, the control program 212 allocates (the number of pages (c)-1) pages to the second successive page allocation region, and then successively allocates the pages 1261 corresponding to the number of pages (c) at intervals of the period (d). In other words, even if a format write request is not actually generated against the virtual address subsequent to the first virtual address of the second successive page allocation region, the pages 1261 can be allocated. By performing such allocation, any of the tables in the shared memory 220 is not required to manage which pages 1261 of a chunk 132 are unallocated, thus there is an advantage that the size of the tables can be kept small. If the pages are allocated in response to a format write request, unallocated pages 1261 of a chunk 132 have to be managed. Therefore, as described above, successive allocation of the pages 1261 on the basis of the obtained number of pates (c) and period (d) is advantages in keeping the size of the tables small.

It should also be noted with respect to this periodic allocation that, if there are no more unallocated pages 1261 in one chunk 132, the control program 212 can search for a different unallocated chunk 132, generate a plurality of pages 1261 from the searched chunk 132, and successively allocate the plurality of pages 1261. In this case, the control program 212 may register information on the plurality of chunks 132 (the addresses or chunk IDs in LUs) in one of the entries 333 on the periodic allocation access conversion list 3311 (see FIG. 3B) or one of the entries 318 on the periodic allocation chunk list 3312 (see FIG. 3D), or may prepare a plurality of entries in order to manage one chunk in one entry consistently, when a plurality of chunks are used in periodic allocation.

The above is the description of the periodic allocation. It should be noted regarding FIG. 5 that (a) shows the first virtual address in the range of format processing, and (b) shows the last virtual address in the range of format processing. In this example, because the entire virtual volume 100 is the target for the format processing, (a) is the first virtual address of the virtual volume 100 and (b) is the last virtual address of the virtual volume 100. In addition, the range of the format processing may be a part of the virtual volume 100. For example, in the case where first and second file systems use one virtual volume 100, the first virtual address and the last virtual address in the range used by the first file system may be (a), (b) described above. In other words, periodic allocation may occur only in the range used by the first file system. Similarly, in a section in which periodic allocation is performed during the format processing, the abovementioned (a) may be positioned in the middle instead of the front. This determines, on the basis of the section where a certain writing occurs (the position of allocation in S607 described hereinafter), the number of pages to be allocated from the section and the period (S608 described hereinafter, for example), thus this writing is attributed to that periodic allocation is possible in any position in the virtual volume 100.

A flow of processing performed in the first embodiment will now be described.

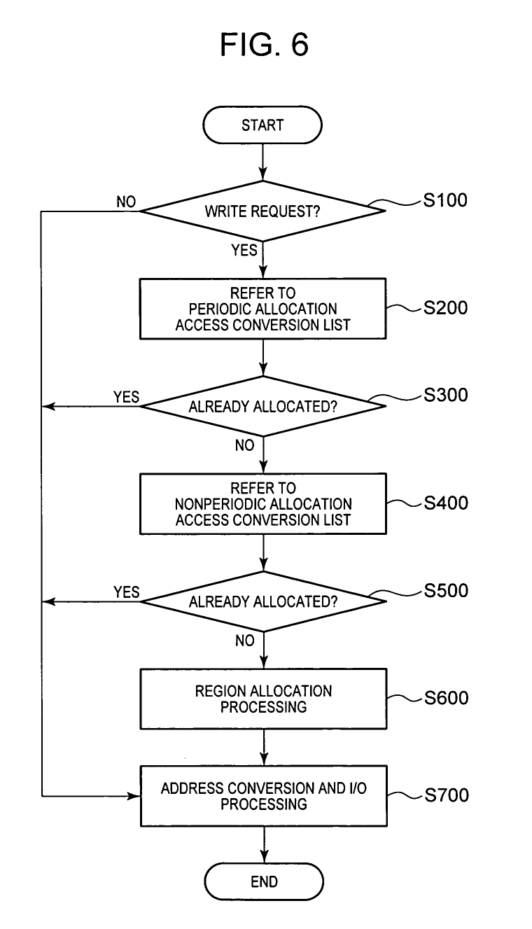

FIG. 6 shows an example of a flow of processing performed by the control program 212 which receives an I/O request.

When the control program 212 receives an I/O request, the control program 212 determines whether the I/O request is a write request or a read request (S100). When the control program 212 determines that the I/O request is a read request (NO in S100), the control program 212 executes S700 described hereinafter.

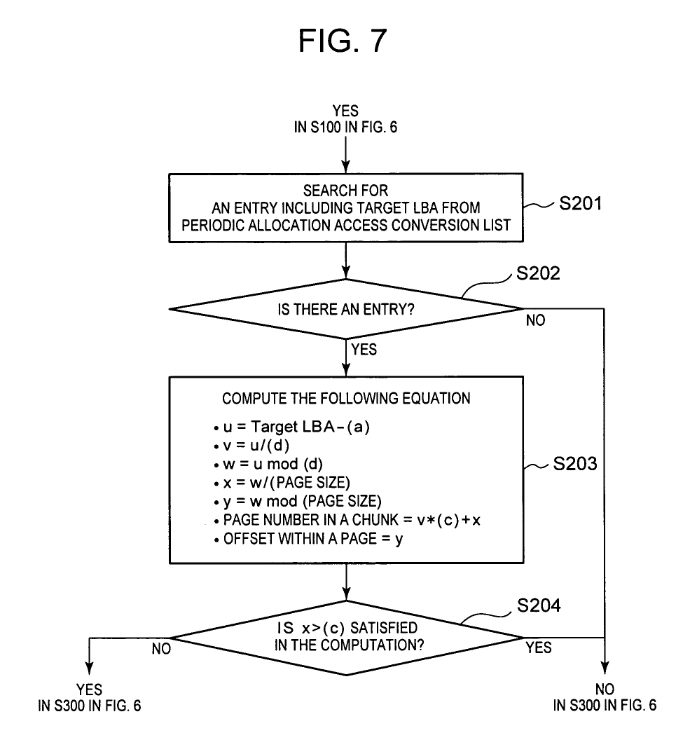

On the other hand, if the control program 212 determines that the I/O request is a write request (YES in S100), the control program 212 refers to the periodic allocation access conversion list 3311 and judges whether the regions are already allocated to the virtual addresses corresponding to the received write request (S200). If the regions are already allocated (YES in S300), the control program 212 executes S700, and if not (NO in S300), executes S400. This processing in S200 is described hereinafter in detail with reference to FIG. 7.

In S400, the control program 212 refers to the nonperiodic allocation access conversion list 3310 to determine whether regions are already allocated to the virtual addresses corresponding to the received write request. If the regions are already allocated (YES in S500), the control program 212 executes S700, and if not (NO in S500), executes S600.

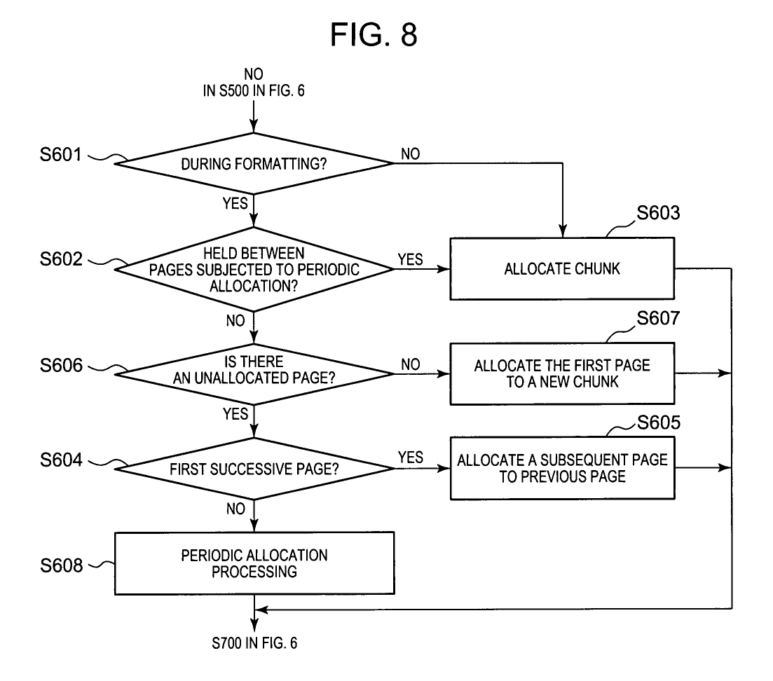

In S600, the control program 212 performs region allocation processing. This processing in S600 is described hereinafter in detail with reference to FIG. 8.

In S700, the control program 212 performs address conversion and I/O processing.

It should be noted that “address conversion” here means that the address of the access destination of a received I/O request is converted from a virtual address to an address in the storage system 13 (a LU address and a set of addresses in a LU). Specifically, for example, in S700 subsequent to S300 in which the result is YES, the control program 212 specifies the number of pages, period, LU address, and addresses within LU from the entries 333 (entries 333 of the periodic allocation access conversion list 3311) having virtual address specified by the I/O request as an address range, and performs computation using the specified number of pages, period, LU address and address within LU (e.g. computation in S203 described hereinafter), whereby the specified virtual address can be converted into an actual address which is allocated to a region (region in the virtual volume 100) including the specified virtual address (address corresponding to the allocated page).

Further, I/O processing involves transmitting an I/O request, which specifies an address obtained after address conversion, to the storage system 13.

FIG. 7 shows the details of the processing in step S200 shown in FIG. 6.

The control program 212 searches for an entry containing a target LBA from the periodic allocation access conversion list 3311 (S201). A target LBA is a LBA specified by the received write request and is a virtual address.

The control program 212 executes S203 when an entry containing the target LBA and having an address range within a virtual volume is found from the periodic allocation access conversion list 3311. If the entry is not found (S202), the result in S300 shown in FIG. 6 is NO, that is, pages are not yet allocated in S200 in FIG. 6.

In S203, the control program 212 computes the following equation.

u=target LBA−(a);

v=u/(d);

w=u mod(d);

x=w/(page size)

y=w mod(page size)

Page number in a chunk=v×(c)+x

Offset within a page=y

In this computation formula, (a) is a first LBA (first virtual address) of an address range inside a virtual volume. (b) is a last LBA (last virtual address) of the address range. (c) is the number of pages allocated to one successive page allocation region. (d) is a period, i.e. an address range between a base point of the first successive page allocation region (first LBA, for example) and a base point of the second successive page allocation region (first LBA, for example). Moreover, (page size) is the size of one page (storage capacity). It should be noted that in the first embodiment, the size of a chunk and the size of a page are uniform and have fixed values, thus the chunk size and the page size are not required to be managed in the various tables. In addition, however, for example, at least either a chunk or a page may be a variable. In this case, all chunks or pages may be set as variables, or one or plurality of the chunks or pages may be variables.

In S203, if x>(c) (YES in S204), the result in S300 in FIG. 6 becomes NO. However, by computing y without obtaining such result (NO in S204), the result in S300 in FIG. 6 becomes YES, that is, a page is allocated to the target LBA.

FIG. 8 shows the details of the processing in step S600 shown in FIG. 6.

The control program 212 determines whether or not the virtual volume is being formatted (S601). The method of determining whether the virtual volume is being formatted or not has several different variations, each of which is described hereinafter.

When the control program 212 determines that the virtual volume is not being formatted (NO in S601), the control program 212 searches for an unallocated chunk from the chunk management table 222 and allocates a searched chunk to a virtual address corresponding to the normal write request (S603). This is because the write request in the case where the virtual volume is not being formatted is a normal write request. In this S603, the control program 212 updates the nonperiodic allocation access conversion list 3310 and nonperiodic allocation chunk list 315.

On the other hand, when the control program 212 determines that the virtual volume is being formatted (YES in S601), the control program 212 determines whether the target LBA is held between pages which are already subjected to periodic allocation (i.e. whether or not the target LBA is positioned between the successive page allocation regions) (S602). Specifically, for example, if either (P) or (Q) described above is fulfilled:

(P) An entry 333 subsequent to the entry 333 containing the target LBA and having an address region within a virtual volume is already set in the periodic allocation access conversion list 3311;

(Q)x>(c) is satisfied in the computation in S203 of FIG. 7,

the result of the determination is that the target LBA is held between pages which are already subjected to periodic allocation. When such a result is obtained (YES in S602), the control program 212 executes the abovementioned S603.

On the other hand, if the result of the determination is that the target LBA is not held between the pages which are already subjected to periodic allocation (NO in S602), the control program 212 determines whether there is an unallocated page in a chunk having a page which is periodically allocated at last minute (S606). Specifically, for example, when a plurality of pages are generated from a chunk, the control program 212 allocates successive page numbers to each page and determines whether there is an unallocated page number. If it is determined that there is not unallocated page (NO in S606), the control program 212 searches for a new unallocated chunk, generates a plurality of pages from the newly searched unallocated chunk, and allocates the first page of the plurality of pages (S607).

In other words, if, for example, the chunk does not have any pages to allocate to the first successive page allocation region, pages are allocated from a different chunk. Alternatively, when allocation of pages to the first successive page allocation region is finished and then allocation of pages to the next successive page allocation region is started, if there are no pages in the chunk, pages are allocated from a different chunk. Such a circumstance occurs when, for example, the size of the successive page allocation regions is smaller than the size of the chunks, or if the size of the successive page allocation regions is same as the size of the chunks.

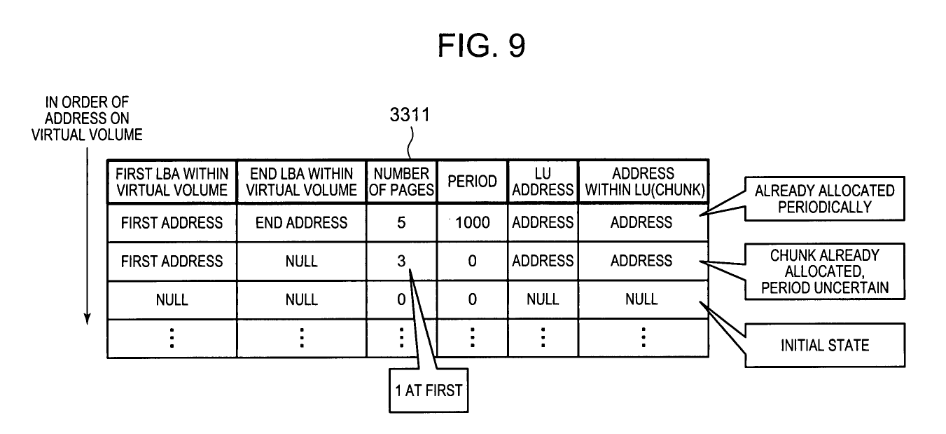

On the other hand, if it is determined in S606 that an unallocated page is present, the control program 212 determines whether the page immediately prior to the target LBA (the page allocated to the last virtual address continuing to the target LBA) is the first continuing page in this chunk (i.e. whether the address of the corresponding page is successive or not when a period is undefined) (S604). In other words, the control program 212 determines whether the allocation destination virtual address of the allocated page immediately prior to the first page of one or more unallocated pages present in the chunk is the immediately anterior virtual address continuing to the target LBA. Specifically, in S604, it is determined whether or not writing of the step (2) shown in FIG. 5 is performed. Specifically, as shown in FIG. 9, in the case where periodic allocation is not carried out at all, the values of the number of pages and the period are “0” as shown in the entry in the third line in the periodic allocation access conversion list 3311, and the values of other items are “NULL”. On the other hand, in the case where allocation to the chunk is completed during the formatting, the LU address and the address within LU are updated to a LU address having the allocated chunk and an address within LU showing the chunk, as shown in the entry in the second line. Moreover, in the case where the period is undefined (i.e. in the case where pages are being allocated to the first successive page allocation region), the number of pages is updated in accordance with the page allocation, but the value of the period remains “0”.

If it is determined that the page immediately prior to the target LBA is the first successive page (YES in S604), i.e. if the periodic allocation access conversion list 3311 shows the entry in the second line in FIG. 9, the control program 212 allocates the page subsequent to the prior page to the target LBA (S605). In other words, allocation of pages to the first successive page allocation region is continued.

On the other hand, if is determined that the page immediately prior to the target LBA is not the first successive page (NO in S604), the control program 212 executes periodic allocation processing (S608). Specifically, the control program 212 takes, as a period, the offset between the front address of the previous successive page allocation region and the allocation destination virtual address of the current page, allocates the rest of the pages of the chunk in this period, and updates the periodic allocation access conversion list 3311 and the periodic allocation chunk list 3312. In S608, pages are allocated in units of the number of pages allocated to the first successive page allocation region, at intervals of the period. This periodic allocation in S608 is carried out before a format write request is actually generated. In other words, in the middle of periodic allocation of S608 or after the periodic allocation, the control program 212 receives the format write request. Therefore, pages are already allocated to the write destination address corresponding to the received format write request. If the period is defined, the value of the period is no longer 0 as shown in the entry in the first line in the periodic allocation access conversion list 3311 shown in FIG. 9. Further, when the periodic allocation in S608 is ended, the ending LBA of the address range within the virtual volume is written. If this ending address is known prior to the start of the processing of S608 (for example, if the entire virtual volume 100 is the target of formatting), the ending address may be written not only when S608 is ended but also prior thereto.

The above is the detailed description of the processing of S600 shown in FIG. 6. It should be noted that there are at least three possible variations (first through third) of the method of determining in S601 whether or not formatting is being performed. These variations are described below.

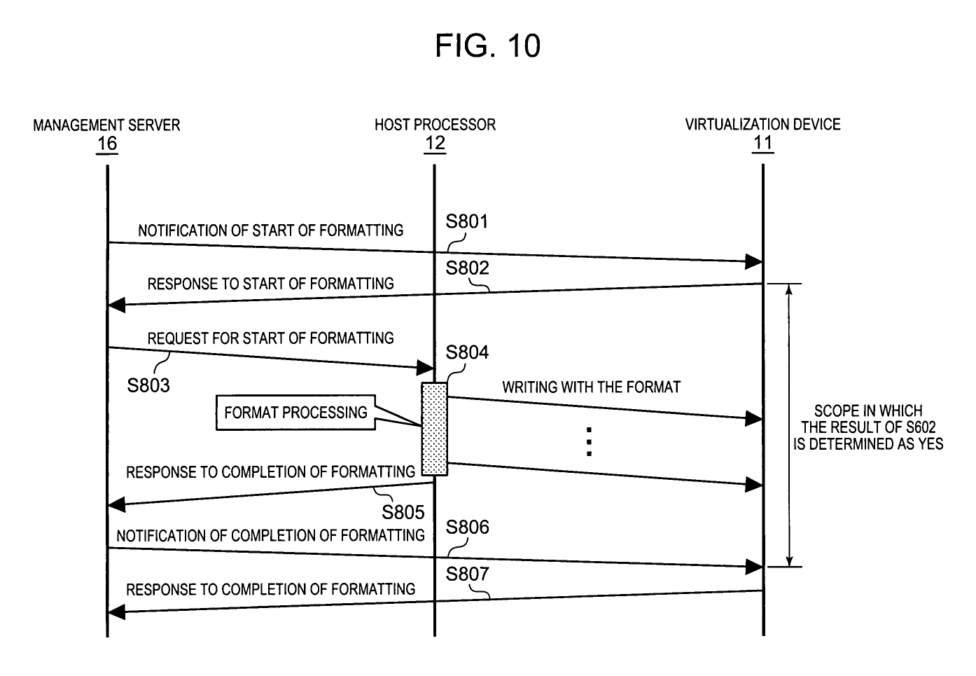

The first variation is described with reference to FIG. 10. This is a method in which the virtualization device 11 determines, based on information received from the management server 16, whether or not the formatting is performed. Specifically, the management server 16 transmits a notification of the start of the formatting operation to the virtualization device 11 (S801), and the virtualization device 11 transmits a format starting response to the management server 16 upon the receipt of the notification of the start of the formatting operation (S802). This point of time is the time point at which determination on whether formatting is being performed or not is started. Thereafter, the management server 16 transmits a format starting request to the host processor 12 (S803). The host processor 12 which receives the format starting request transmits a format write request to the virtualization device 11 to perform format processing (S804). When the format processing is finished, the host processor 12 transmits a format completion response to the management server 16 (S805). The management server 16 transmits a format completion notification to the virtualization device 11 upon reception of the format completion response (S806). The point of time at which the virtualization device 11 receives the format completion notification is the time point at which determination on whether formatting is being performed or not is ended. The virtualization device 11 transmits a format completion response to the management server 16 (S807).

The second variation involves a method in which the virtualization device 11 determines from information received from the host processor 12 whether formatting is being performed. Specifically, for example, in the flow of processing shown in FIG. 10, the processing executed by the management server 16 is executed by the host processor 12. At this moment, exchange performed between the management server 16 and the host processor 12 shown in FIG. 10 may be omitted. In other words, the host processor 12 notifies the format starting notification or format completion notification to the virtualization device 11, whereby the virtualization device 11 can be provided with a cause to start or end determining that formatting is being performed.

The third variation involves a method in which determination is made as to whether formatting is being performed or not, on the basis of whether the number of times non-periodic allocation (S603) is performed after starting periodic allocation (S608) (after ending the periodic allocation, for example) exceeds a predetermined threshold or not. Specifically, for example, after periodic allocation is started, the control program 212 counts the number of times non-periodic allocation (S603) is performed. Until the counted number exceeds the predetermined threshold, the control program 212 determines that formatting is being performed, and, after the predetermined threshold is exceeded, determines that formatting is not being performed. Even if formatting is actually being performed, there is a case in which all of the periods and all of the pages are not necessarily uniform. For example, the period (distance) between the first and second successive page allocation regions and the period between the third and fourth successive page allocation regions are not necessarily the same. Similarly, for example, the number of pages allocated to the first successive page allocation region and the number of pages allocated to the second successive page allocation region are not necessarily the same. In this case, when performing writing in accordance with the format write request receive after periodic allocation, the address of an unallocated region, which is different from the allocation destination address of a page, is the target LBA, thus not pages but chunks are allocated. However, even if the write destination corresponding to the actual format write request is the place away from the place where pages are allocated periodically, failure in writing (formatting) can be prevented. Moreover, the number of times that non-periodic allocation is performed is smaller than the number of times that writing performed is in accordance with the normal write request. Therefore, the abovementioned predetermined threshold is a value obtained in view of the above-described fact. In the third variation, whether formatting is being performed or not can be determined accordingly, while preventing the occurrence of failure in writing in accordance with the format write request.

Presented above, was the description of the first embodiment. In the first embodiment, the size of a page can be, for example, set at least smaller than the size of one metadata item which is written when formatting is performed.

According to the first embodiment described above, a page, which is a storage region smaller than a chunk, is allocated when region allocation is performed during formatting of the virtual volume is performed, thus the occurrence of unused sections in the allocated region can be performed. Further, in region allocation during formatting, a plurality of pages are cut out from one chunk and allocated, thus the shared memory 220 does not have to be accessed each time when allocating one page and may be accessed when searching for an unallocated chunk which is the source of the pages. Therefore, the number of times that the shared memory 220 is accessed during formatting can be kept low.

### Embodiment 2

The second embodiment of the present invention will now be described. In the below description, the differences between the first embodiment and the second embodiment will be emphasized, while the description of the similarities with the first embodiment are omitted or abbreviated (same applies to the third embodiment).

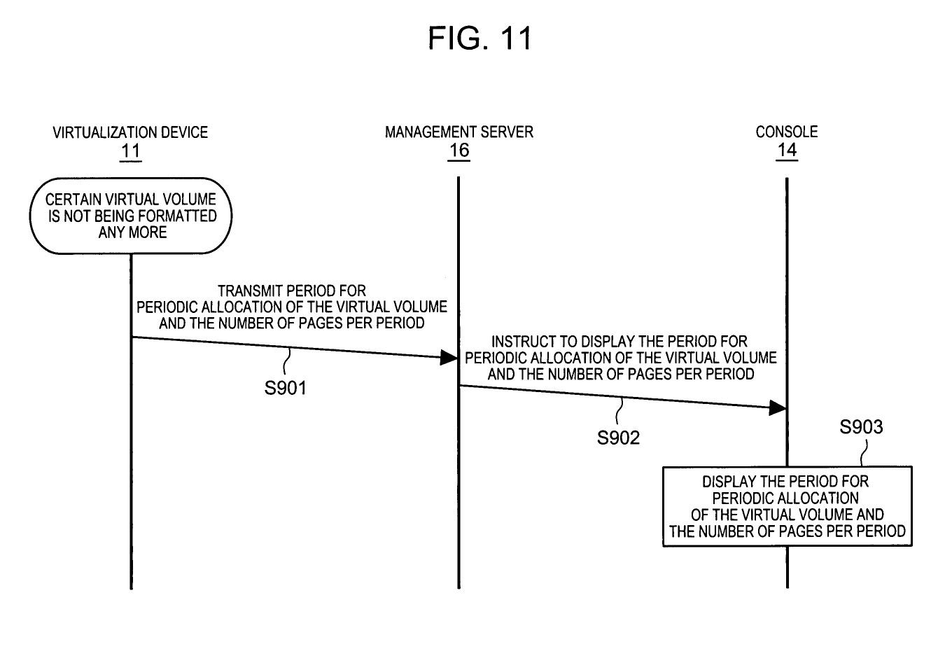

FIG. 11 shows an example of a flow of processing performed in the second embodiment of the present invention.

When the formatting of a certain virtual volume is being completed, the control program 212 of the virtualization device 11 transmits information related to a period for periodic allocation with this virtual volume and the number of pages per period (i.e. the number of pages allocated to one successive page allocation region existing in one period) (“period/number of pages information” hereinafter) to the management server 16 (S901).

The management server 16 transmits the received period/number of pages information to the console 14 and instructs the console 14 to display the period/number of pages information (S902).

The console 14 displays the period/number of pages information received from the management server 16 in accordance with the instruction from the management server 16 (S903).

The above description pertains to the second embodiment of the invention. It should be noted that the timing for starting S901 may not only be timing when a certain virtual volume is not being formatted any more, but also other timing. For example, even during formatting of the virtual volume, S901 may be performed at the time when the period and the number of pages are obtained.

Further, in the second embodiment the control program 212 can select the period and the number of pages to transmit to the management server 16, in the manner described hereinafter. Specifically, for example, the control program 212 can select the period and the number of pages used in certain timing (for example, the period and the number of pages used in a chunk subjected to the last periodic allocation), as transmission targets. Alternatively, for example, the control program 212 can select the period and the number of pages which are used in the largest number of chunks, as the transmission targets. The period and the number of pages which are used in the largest number of chunks can be specified by, for example, taking a byte sequence connecting a period and the number of pages as an index and creating a table having values of the number of chunks. In other words, when searching for a chunk which is the base of a page, a value of a position corresponding to the number of pages and the period, which are used in allocation of a page cut out from this chunk (the number of chunks), is updated, and a pair of the number of pages and a period corresponding to the largest value obtained after update can be specified.

As described above, in the second embodiment, an administrator, who views the page/number of pages information displayed by the console 14, can operate the console 14 when formatting other virtual volume, and instruct the virtualization device 11 having this virtual volume to perform periodic allocation using the displayed period and the number of pages. Specifically, in the first embodiment the virtualization device 11 learns the period and the number of pages and performs periodic allocation based on the result from the learning, while in the second embodiment the virtualization device 11 can perform periodic allocation using the period and the number of pages specified from the console 14. In other words, in the second embodiment pages can be allocated through periodic allocation from the first successive page allocation region.

### Embodiment 3

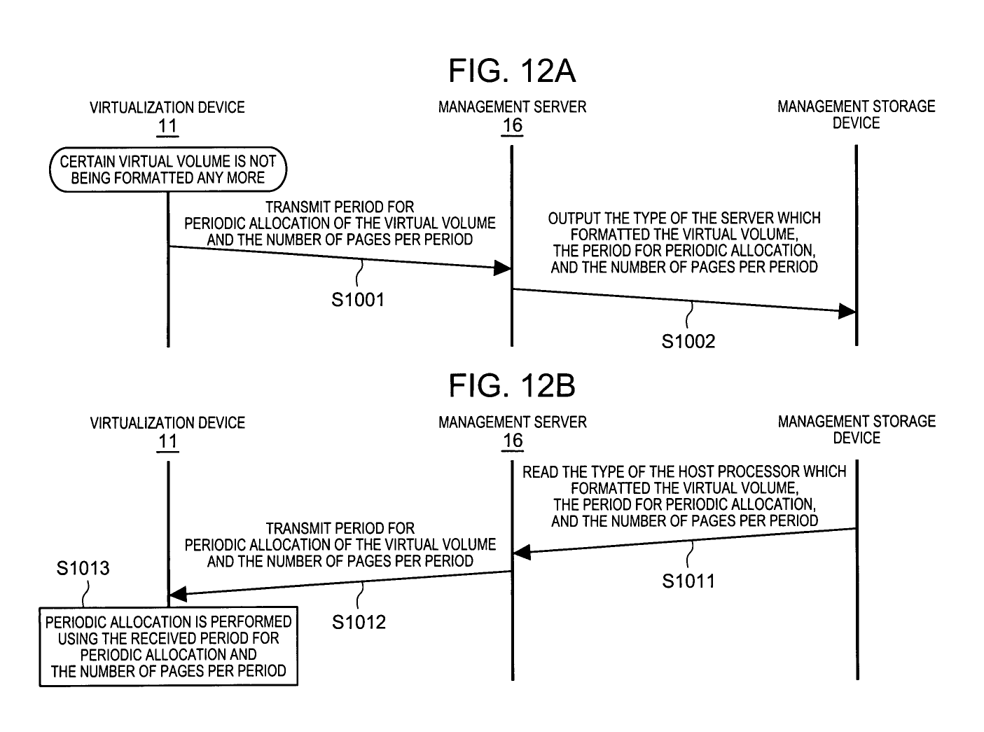

FIG. 12A shows a partial exemplary flow of processing performed in the third embodiment of the present invention. FIG. 12B shows the remaining exemplary portion of the abovementioned processing.

As shown in FIG. 12A, when the formatting of a certain virtual volume is being completed, the control program 212 of the virtualization device 11 transmits period/number of pages information related to a period for periodic allocation with this virtual volume and the number of pages per period, to the management server 16 (S1001). The period and the number of pages as the transmission targets can be selected in the same way as with the second embodiment.

The management server 16 outputs the received period/number of pages information and the information related to the type of server which formats the certain virtual volume (“server type information”, hereinafter) to a management storage device (S1002). Accordingly, a set of the period/number of pages information and the server type information is stored in the management storage device. It should be noted that the server type indicated by the server type information can be a type of a server which issues a format starting request to the host processor or which performs format processing in place of the host processor (for example, a type of an OS (operating system) mounted on this server). Furthermore, the management storage device is a storage device incorporated in the management server 16 of a storage device which exists outside of the management server 16 and can communicate with the management server 16. The storage device may be stationary or portable.

As shown in FIG. 12B, the management server 16 reads an information set of the period/number of pages information and host processor type information from the management storage device (S1011). The information set which is read here is an information set having host processor type information related to the type of the host processor 12, which formats the virtual volume of the information set.

The management server 16 transmits the period/number of pages information included in the read information set to the virtualization device 11 (S1012).

The control program 212 of the virtualization device 11 performs periodic allocation with the period and the number of pages (S1013). It should be noted that the virtual volume which is subjected to periodic allocation may be a predetermined virtual volume or a virtual volume specified from the management server 16.

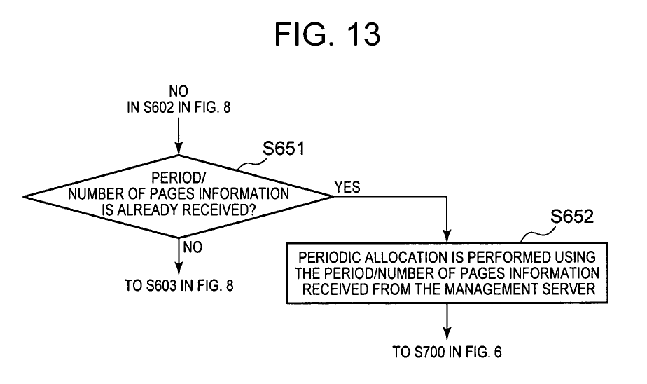

FIG. 13 shows a flow of region allocation processing in the third embodiment. It should be noted that FIG. 13 shows the differences with FIG. 8.

Specifically, in the case of NO determination in S602 of FIG. 8, the control program 212 determines whether the period/number of pages information is already received or not (S651). If it is not received (NO in S651), S603 shown in FIG. 8 is carried out, and if received, S652 is carried out.

In S652 the control program 212 performs periodic allocation on the basis of period/number of pages which are indicated by the received period/number of pages information. At this moment, the control program 212 updates the periodic allocation access conversion list 3311 and periodic allocation chunk list 3312.

### Embodiment 4

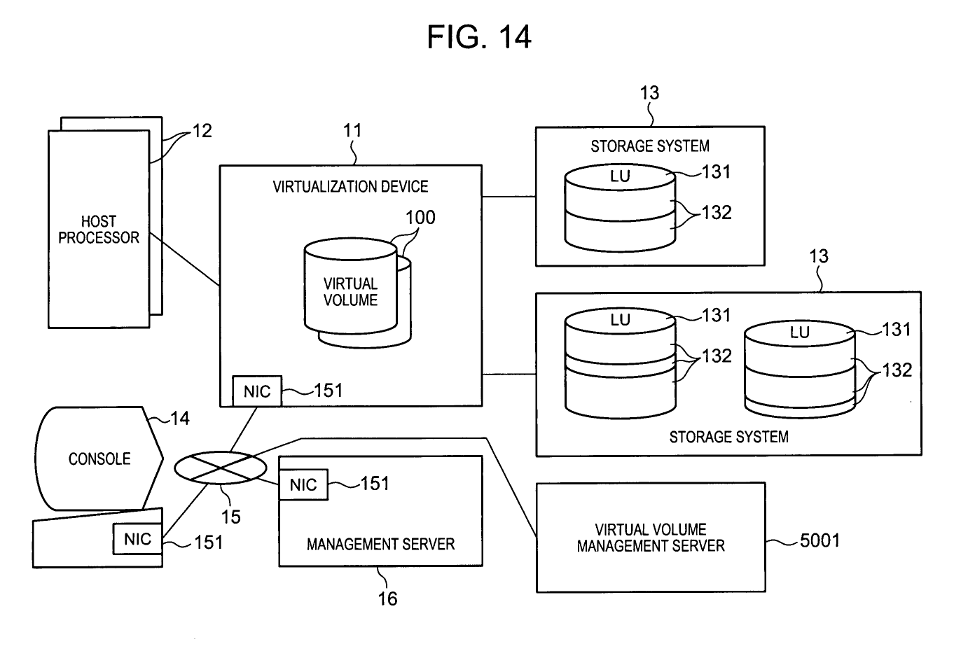

FIG. 14 shows a configuration example of the computer system according to the fourth embodiment of the present invention.

According to this computer system, a virtual volume management server 5001 is connected to the virtualization device 11 via a communication network 15. The virtual volume management server 5001 controls region allocation to the virtual volume 100. The virtual volume management server 5001 and the virtualization device 11 can communicate with each other via the communication network 15.

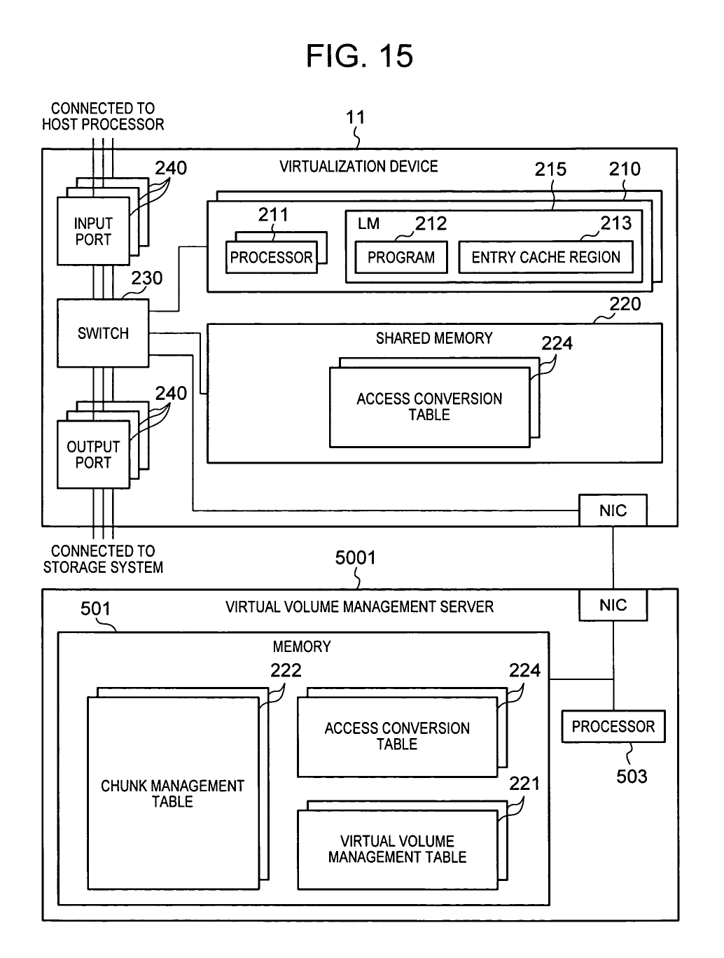

FIG. 15 shows a configuration example of the virtualization device 11 and virtual volume management server 5001.

The virtualization device 11 has the access conversion table 224, and the virtual volume management server 5001 has all of the tables 224, 222, 221 in the memory 501. The access conversion table 224 of the virtual volume management server 5001 can have the same contents as the access conversion table 224 of the virtualization device 11. Instead, the virtual volume management server 5001 may refer to the access conversion table 224 of the virtualization device 11 without having the access conversion table 224.

As described above, out of the various tables 224, 222, 221 described in the first embodiment, at least the chunk management table 222 and the virtual volume management table 221 are stored in the memory 501 of the virtual volume management server 5001 (or in a different type of storage resource instead). A processor 503 of the virtual volume management server 5001 refers to the tables 222, 221 during the processing.

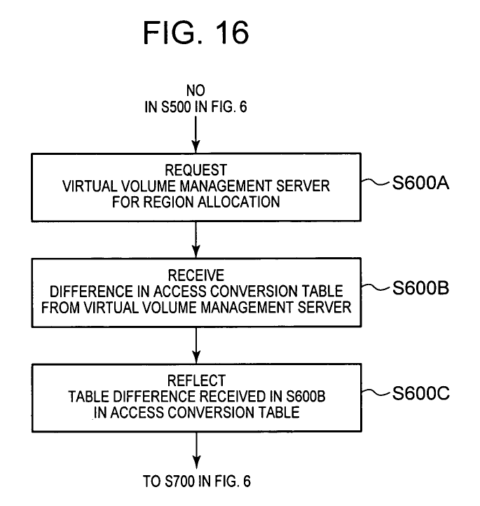

FIG. 16 shows an example of a flow of processing performed by the computer program 212 which receives an I/O request in the fourth embodiment. FIG. 16 shows the differences with the first embodiment.

In the case of NO in S500 of FIG. 6, the control program 212 requests the virtual volume management server 5001 to perform region allocation (S600A). In accordance with this request, the virtual volume management server 5001 executes region allocation with the same flow as S600 of FIG. 6. In this region allocation processing, the access conversion table 224 of the virtual volume management server 5001 is updated. The virtual volume management server 5001 transmits the difference between the access conversion table 224 before update and the access conversion table 224 after update (“table difference”, hereinafter) to the virtualization device 11.

The control program 212 receives the table difference from the virtual volume management server 5001 (S600B). The control program 212 then reflects the table difference in the access conversion table 224 of the virtualization device 11 (S600C). Accordingly, the contents of the access conversion table 224 of the virtualization device 11 become the same as those of the updated access conversion table 224 of the virtual volume management server 5001.

As described above, in the fourth embodiment, the region allocation processing and the processing involving referring to the various lists 3310, 3311 of the access conversion table 224 can be performed by, not the virtualization device 11, but the virtual volume management server 5001.

Described above were several preferred embodiments of the present invention. However, it should be understood that the described embodiments are merely examples of the implementation of the present invention and are not intended to limit the scope of the present invention to the described embodiments. The present invention can also be implemented in various other embodiments.

For example, the function as the virtualization device may be incorporated in the controller of the storage system 13. In this case, the above-described various tables 221, 222, 224 and the control program 212 may be stored in the memory of the controller, and the control program 212 may be executed by the CPU of the controller.

Moreover, for example, an external storage system may be connected to the storage system 13. In this case, a plurality of chunks may exist in the external storage system, and the storage system 13 may cut out a page from an unallocated chunk present in the external storage system and allocate the page to a virtual volume.

Finally, it should be understood that processes and techniques described herein are not inherently related to any particular apparatus and may be implemented by any suitable combination of components. Further, various types of general purpose devices may be used in accordance with the teachings described herein. It may also prove advantageous to construct specialized apparatus to perform the method steps described herein. The present invention has been described in relation to particular examples, which are intended in all respects to be illustrative rather than restrictive. Those skilled in the art will appreciate that many different combinations of hardware, software, and firmware will be suitable for practicing the present invention. For example, the described software may be implemented in a wide variety of programming or scripting languages, such as Assembler, C/C++, perl, shell, PHP, Java, etc.

Moreover, other implementations of the invention will be apparent to those skilled in the art from consideration of the specification and practice of the invention disclosed herein. Various aspects and/or components of the described embodiments may be used singly or in any combination in the computerized storage system. It is intended that the specification and examples be considered as exemplary only, with a true scope and spirit of the invention being indicated by the following claims.

What is claimed is:

1. A virtualization system for allocating an unallocated real region of a plurality of real regions to a write destination of a write request for a virtual volume provided to a host device, the virtualization system comprising:
a request receiving section, which receives the write request for the virtual volume;
a determining section, which, upon receipt of the write request for the virtual volume, is operable to determine whether or not the virtual volume is being formatted;
a storage section operable to store management information comprising information indicating whether or not each of the plurality of real regions is unallocated; and
a region allocation control section, operable, upon determination that the virtual volume is being formatted, to specify an unallocated real region from the plurality of real regions with reference to the management information, to divide the specified unallocated real region into a plurality of sub regions, and to allocate the plurality of sub regions.

2. The virtualization system according to claim 1, wherein upon determination that the virtual volume is not being formatted, the region allocation control section is operable to allocate the specified unallocated real region itself to the write destination of the write request, in response to the write request for the virtual volume.

3. The virtualization system according to claim 1, wherein the storage capacity of the real region and the storage capacity of each of the sub regions are both of fixed value.

4. The virtualization system according to claim 1, wherein the region allocation control section is operable to allocate the successive sub regions to each write destination in the format in the first successive region of the virtual volume, and, when allocating a sub region to the first write destination of a subsequent successive region, to obtain a successive region interval representing the difference between the write destination and the first write destination of the first successive region, and further to allocate successive sub regions, the number of which is the number of the sub regions allocated to the first successive region, to each of successive regions following the subsequent successive region.

5. The virtualization system according to claim 4, wherein prior to receiving a write request for each of the successive regions following the subsequent successive region, the region allocation control section is operable to allocate successive sub regions to each of the successive regions following the subsequent successive region.

6. The virtualization system according to claim 4, wherein, after allocating the successive sub regions to the successive regions following the subsequent successive region, the region allocation control section is operable to allocate an unallocated real region to the write request, when the position of the write destination of the received write request is different from that of the successive region regardless of whether the virtual volume is being formatted.

7. The virtualization system according to claim 6, further comprising a counting section, operable to count the number of times that the position of the write destination of the received write request is different from that of the successive region, wherein when the number of times exceeds a predetermined value, the determining section is operable to determine that the virtual volume is not being formatted.

8. The virtualization system according to claim 1, further comprising a notification receiving section, operable to receive a notification of the start of formatting of the virtual volume and a notification of the end of the formatting from the host device or an external device which is different from the host device, wherein when the notification of the start of formatting is received, the determining section is operable to determine, until the notification of the end of the formatting is received, that the virtual volume is being formatted.

9. The virtualization system according to claim 1, further comprising a notifying section, operable to notify a predetermined computer of a successive region interval representing a difference between a base point of a certain successive region and a base point of a subsequent successive region, and the number of sub regions allocated to one successive region.

10. The virtualization system according to claim 1, further comprising an input section, operable to input the successive region interval and the number of sub regions from outside of the virtualization system, wherein the region allocation control section allocates successive sub regions, the number of which is the number of the input sub regions, at the input successive region intervals.

11. The virtualization system according to claim 1, wherein
the virtualization system is a storage system;
the storage system comprises a plurality of storage devices and a controller;
the plurality of storage devices are provided with at least one logical volume composed from the plurality of real regions;
the controller has the request receiving section, determining section, storage section, and region allocation control section; and
the region allocation control section is operable to write data corresponding to a write request received by the request receiving section, into an allocated sub region.

12. The virtualization system according to claim 1, wherein
the virtualization system is a storage system connected to an external storage system;
the storage system comprises a plurality of storage devices and a controller;
the external storage system is provided with at least one logical volume composed from the plurality of real regions;
the controller has the request receiving section, determining section, storage section, and region allocation control section; and
the region allocation control section is operable to write data corresponding to a write request received by the request receiving section, into an allocated sub region.

13. The virtualization system according to claim 1, wherein
the virtualization system is a switching device, which is disposed between the host device and the storage system, and
the plurality of real regions are components of at least one logical volume provided in the storage system.

14. The virtualization system according to claim 1, comprising a switching device disposed between the host device and the storage system, and a management device communicably connected with the switching device, wherein
the switching device has the request receiving section and a requesting section which requests for determination on whether the virtual volume is being formatted or not,
and wherein the management device has the determining section operable to perform the determination in response to the request, the storage section, and the region allocation control section.

15. The virtualization system according to claim 1, wherein
the management information includes first management sub information for managing allocation of a real region itself to the virtual volume, and second management sub information for managing allocation of a sub region to the virtual volume,
and wherein the region allocation control section is operable to update the first management sub information when the unallocated real region itself is allocated to the virtual volume, and to update the second management sub information when the sub region is allocated to the virtual volume.

16. The virtualization system according to claim 15, wherein the second management sub information comprises a successive region interval, representing a difference between a base point of a certain successive region and a base point of a subsequent successive region, and the number of sub regions allocated to one successive region.

17. The virtualization system according to claim 1, wherein
the storage capacity of the real region and the storage capacity of each of the sub regions are both of fixed value,
the management information comprises first management sub information for managing allocation of an real region itself to the virtual volume, and second management sub information for managing allocation of a sub region to the virtual volume, and
the region allocation control section is operable to execute following steps (A) through (C) of:
(A) allocating, upon determination that the virtual volume is not being formatted, the specified unallocated real region itself to the write destination of a write request, in response to the write request for the virtual volume;
(B) allocating, upon determination that the virtual volume is being formatted, successive sub regions to each write destination in the format in a first successive region of the virtual volume, and, when allocating a sub region to a first write destination of a subsequent successive region, obtaining a successive region interval representing a difference between the write destination and the first write destination of the first successive region, and further allocating successive sub regions, the number of which is the number of the sub regions allocated to the first successive region, to each of successive regions following the subsequent successive region, prior to receiving a write request for each of the successive regions following the subsequent successive region; and
(C) updating the first management sub information when the unallocated real region itself is allocated to the virtual volume, and updating the second management sub information when the sub region is allocated to the virtual volume.

18. A region allocation control method for allocating an unallocated real region of a plurality of real regions to a write destination of a write request for a virtual volume provided to a host device, the region allocation control method comprising:
determining whether the virtual volume is being formatted or not;
specifying, upon determination that the virtual volume is being formatted, an unallocated real region out of the plurality of real regions with reference to management information comprising information indicating whether or not each of the plurality of real regions is unallocated;
dividing the specified unallocated real region into a plurality of sub regions; and
allocating the plurality of sub regions to each of successive regions which are arranged at regular intervals in the virtual volume.
